(19) United States
(12) Patent Application Publication
(10) Pub. No.: US 2009/0319653 A1
(43) Pub. Date: Dec. 24, 2009

(54) SERVER CONFIGURATION MANAGEMENT METHOD

(75) Inventors: Dean Lorenz, Haifa (IL); Yosef Moatti, Haifa (IL)

Correspondence Address: CONNOLLY BOVE LODGE & HUTZ LLP;(FOR IBM YORKTOWN), P.O. BOX 2207, WILMINGTON, DE, 19899-2207, US

(73) Assignee: International Business Machines Corporation, Armonk, NY (US)

(21) Appl. No.: 12/143,340

(22) Filed: Jun. 20, 2008

(51) Int. Cl. G06F 15/173

(52) U.S. Cl. 709/224

(57) ABSTRACT

A method for monitoring changes in at least two servers, that creates difference results that encapsulate effects of changes applied to file systems of at least two servers. These differences results are defined by predetermined creation rules. The method includes comparing the difference results between the at least two servers to detect differences in the respective difference results. These detected differences are defined in accordance with predetermined comparison rules. The method further includes: analyzing the detected differences in comparison results in accordance with predetermined analysis rules and indicating potential problems from the analyzed and detected differences.

### FIELD OF THE INVENTION

The present invention generally relates to the field of computer system monitoring and software configuration management and, more particularly, to a method for monitoring changes that take place during the software update process applied to a plurality of similar servers.

### BACKGROUND OF THE INVENTION

Change monitoring is an integral part of the life-cycle of a server. Every now and then, changes must he applied to the server to support bug fixes, policy changes, security issues, software updates, new installs, etc. Typically a server change is applied to a set of servers which may be homogenous (e.g., all servers that belong to a particular service tier, in this case the System Administrator (SA) would typically try to keep the servers as close as possible each to another) or heterogenous (e.g., many desktops that may have been deployed from a single golden image but which were not further synchronized). The change is tested on a “representative” server and then applied to all other servers, with the hope that the change will have the same effect on all servers. Differences between servers increase the chances of errors. Therefore, if possible, a SA attempts to keep their servers as similar to each other as possible. Indeed, monitoring and enforcing similarity between servers is a common and major work item for a SA. In particular, during a change, the SA must monitor the process to verify that it works on every server.

In the background art, a common practice is to monitor a change application on a given server by a version comparison. That is, the file system state before and after the change was applied is compared. For example, there are tools that can show you a log of file-system changes that reflect the change process. However, it is difficult to analyze the difference set and decide whether the recorded changes are in line with what was expected (i.e., which changes are valid and which indicate a possible problem).

In addition, there are background art examples that compare servers to one another (e.g., using the UNIX “diff” command). For example, U.S. Patent Publication No. US 2003/023343 (the '343 application) discloses a method and system for model-based, heterogeneous server configuration management. In particular, the method and system of the '343 application for configuring heterogeneous servers across a network through modules that can browse, snapshot, track changes, track compliance, correct server objects on each of the servers, and provision new servers. By comparing server's to a reference model, discrepancies in the software configuration of the servers can be identified and corrected. As an alternative to the above-discussed reference model, an arbitrary snapshot or scheduled snapshots of a server can be used to track change and compliance in that server.

However, since even homogenous servers are not identical (i.e., some of their configuration files are typically different since based on the server “persona” (e.g., IP address, hostname, . . . ), a problem with the above-discussed background art approach is that one needs to be able to analyze the difference set and decide which changes are valid (e.g., occur “naturally”, such as logs or tmp directory content) and which changes indicate an undesired state in the server (e.g., some action that was mistakenly or maliciously taken on the target server).

Further, existing tools for server configuration management that compare servers (i.e., either one server to another, or one version to another on the same server) are inefficient since they produce a large data output that is hard to analyze. In consideration of the above discussion, there is a need in the art for tools that can systematically narrow down the difference set (e.g., beyond statically pie-configured rules, such as “Ignore /tmp”) to focus the SA on important differences that may indicate a problem. In addition, there is a need in the art, for a tool that combines a versions compare with server-to-server compare and that analyzes a set of results from several compare operations rather than post-filter the result of a single compare operation.

### SUMMARY OF THE INVENTION

An embodiment of the invention is a method for monitoring changes in at least two servers, comprising: creating difference results that encapsulate effects of changes applied to file systems of at least two servers, wherein the differences are defined by predetermined, creation rules; comparing the difference results between the at least two servers to detect differences in the respective difference results, wherein the detected differences are defined in accordance with predetermined comparison rules; analyzing the detected differences in comparison results in accordance with predetermined analysis rules; and indicating potential problems from the analyzed and detected differences.

Yet another embodiment of the invention is a method for monitoring changes in a plurality of servers, comprising: creating, difference results that encapsulate effects of changes applied to file systems of at least one server (this is a reference server, in the sense that the modified server may have been successfully tested thoroughly), wherein the differences are defined by predetermined creation rules; creating difference results that encapsulate effects of changes applied to file systems of at least two additional servers, wherein the differences are defined by additional predetermined creation rules; comparing the difference results between the at least one server (the reference server) to the difference results of the at least two additional servers to detect differences in the respective difference results, wherein the detected differences are defined in accordance with predetermined comparison rules; analyzing the detected differences in comparison results in accordance with predetermined analysis rules; and indicating potential problems from the analyzed and detected differences.

In the above-discussed embodiments of the invention, preferably the method further comprises: storing a snapshot of the file systems of the at least two servers before the changes; storing a snapshot of the file system of the at least two servers after the changes; comparing the before snapshot and after snapshot of the changes in each of the at least two servers.

In addition, in the above-discussed embodiments of the invention, the before snapshot and after snapshot are compared using UNIX or LINUX diff commands. Further, in embodiments of the invention, storing the before snapshot and after snapshot further comprises using at least one of copy-on-write and logical snapshot storage semantics. Further, in the embodiments of the invention, creating difference results further comprises tracking and logging file system changes while the changes are applied. Moreover, in embodiments of the invention analyzing further comprising: applying at least one of user annotation and historical knowledge.

### BRIEF DESCRIPTION OF THE DRAWINGS

The invention can be described in greater detail with the aid of the following drawings.

FIG. 1A illustrates an exemplary flow diagram for monitoring a change in a single server,

FIG. 1B illustrates another exemplary flow diagram for monitoring a change in a single server.

FIG. 1C illustrates yet another exemplary flow diagram for monitoring a change in a single server.

FIG. 2 illustrates an exemplary flow diagram for monitoring a change in two servers.

FIG. 3 Illustrates an exemplary flow diagram for monitoring a change in two servers that includes comparing differences and storing results.

FIG. 4 illustrates an exemplary flow diagram for monitoring a change in two servers that includes comparing, storing, and analyzing differences to identify potential problems.

FIG. 5 illustrates an exemplary flow diagram for monitoring a change in a plurality of servers that includes comparing, storing and analyzing differences to identify potential problems.

FIG. 6 illustrates yet another exemplary flow diagram for monitoring a change in a plurality of servers.

### DETAILED DESCRIPTION OF THE PREFERRED EMBODIMENT

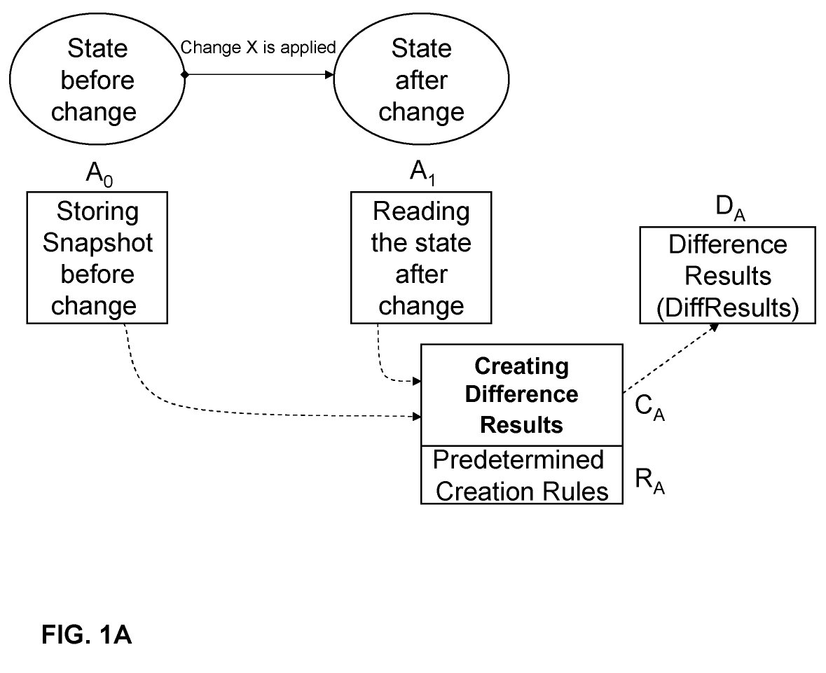

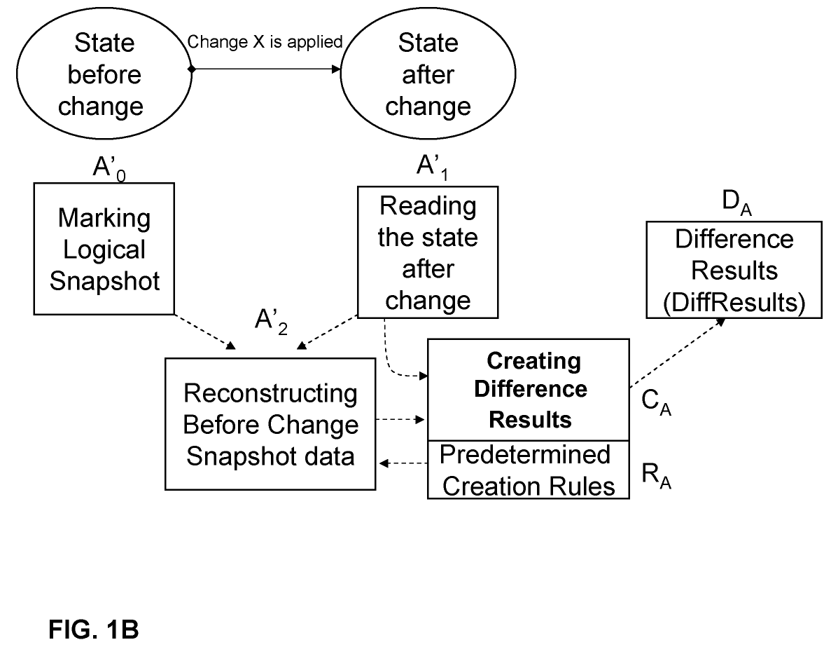

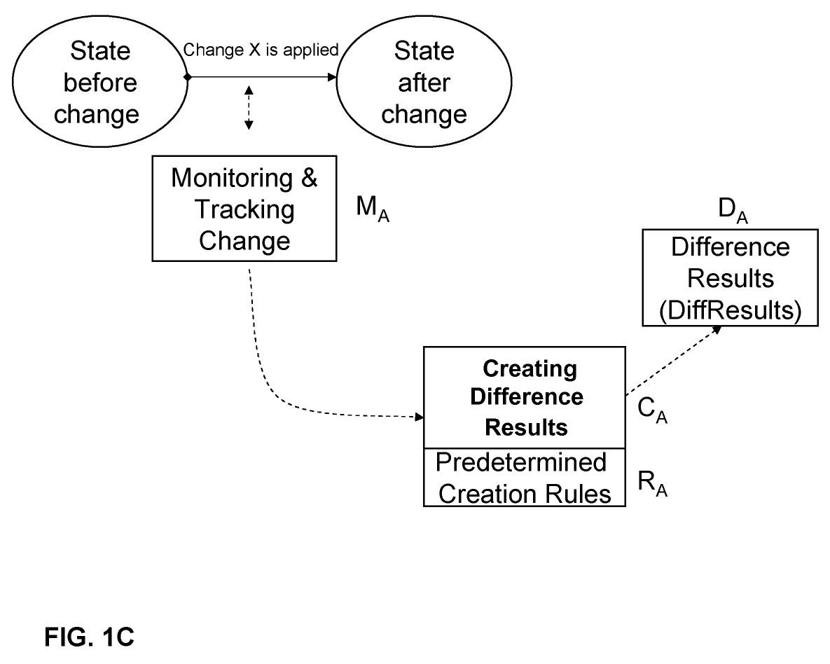

FIG. 1A illustrates an exemplary flow diagram for monitoring a change in a single server. In particular, FIG. 1A includes storing a snapshot of the file system before a change is applied at A₀. After the change is applied, the current state of the file system is read at A₁. Creating difference results occurs at C_{A}, wherein predetermined creation rules R_{A} are used to identify the difference results that are store at D_{A}.

An example will further illustrate the method implemented In FIG. 1A. A Change X is a script that replaces the network mask from 255.255.255.224 to 255.255.255.0. Difference Results (DiffResults) D_{A} in /etc/sysconfig/network/ifcfg-eth0 would show:

−NETMASK=‘255.255.255.224’

+NETMASK=‘255.255.255.0’.

FIG. 1B illustrates another exemplary flow diagram for monitoring a change in a single server. In particular, FIG. 1B includes marking a logical snapshot of the file system at A′₀. After the change is applied, the current state of the file system Is read at A₁. Creating difference results occurs at CA, after reconstructing relevant portions of the state before change at A′₂ using stored logical snapshot information and current state. Only the relevant portions of the state before change are reconstructed. Determining which portions of the state-before-change need to be reconstructed is done at A′₂ according to the predetermined creation rules R_{A} and change markers stored at A′₀. The predetermined creation rules R_{A} are then used to identify the difference results that are stored at D_{A}.

An example will further illustrate the method Implemented in FIG. 1B. A Change X is a script that modifies a particular file named x.txt. Logical snapshot information would indicate that x.txt has changed. The predetermined creation rules R_{A} indicate that such a change needs to be recorded, so the pre-change file has to be reconstructed. The pre-change file x.txt[before]content is logically reconstructed from the current file x,txt[after] and change information stored in the snapshot data, and is then compared to the current file content x.txt[after] to create the difference results. An example of snapshot data would be ail the blocks of x.txt[before] that have been overwritten in x.txt[after]. Reconstructing x.txt[before] can be done by cloning x.txt[after] and replacing the overwritten blocks with their original stored content.

FIG. 1C illustrates yet another exemplary flow diagram for monitoring a change in a single server. In particular, FIG. 1C includes monitoring and tracking changes in the file system at M_{A}. As a non-limiting example of monitoring and tracking changes, each write to disk may be interceptd and logged while the change is executed. The outputs of monitoring and tracking changes are then used to create difference results at C_{A}, wherein predetermined creation rules R_{A} are used to identify the difference results that are store at D_{A}.

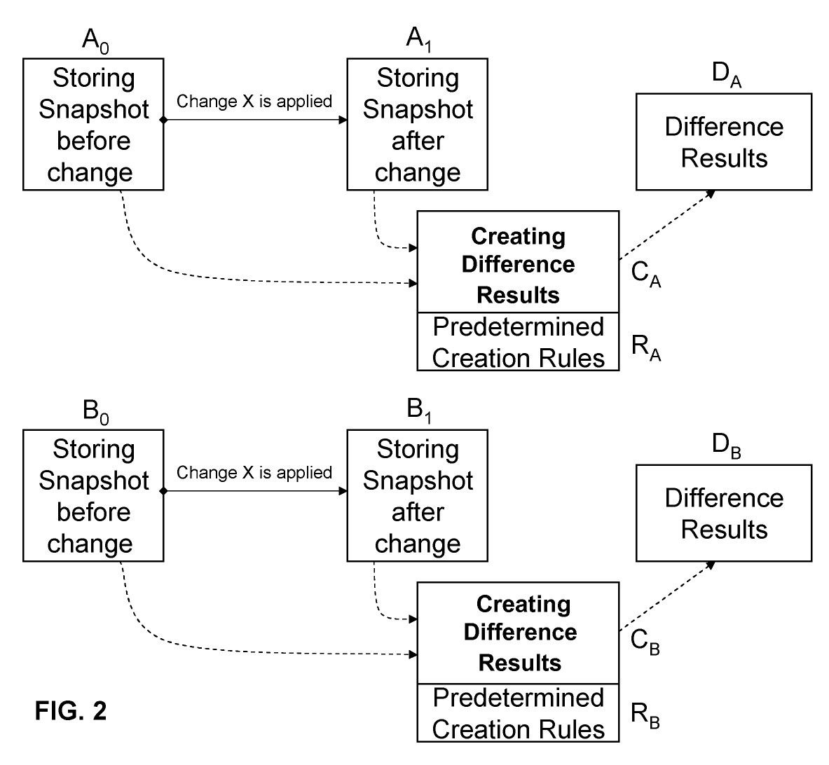

Any of the configurations shown in FIG. 2 to FIG. 6 below that include the “creating differences” function may use any of the various configurations for providing the input sources illustrated in FIG. 1A to FIG. 1C above. The implementation of the predetermined rules is dependent on the tool which was used for obtaining the Difference Results and also the presentation format of the Difference Results.

As an examples of the operation of some of these predetermined rules, assume that we use the UNIX/LINUX diff tool to compare A₁ (resp. B₁) with A₀ (resp. B₀). If we desire to ignore the content of the /imp, we could use the following example for “Ignoring the content of /tmp” (note: we assume in the following that directory TTT0 contains the file system that corresponds to A₀ and TT1 the file system that corresponds to A₁).

The first recursive difference between A₀ and A₁ would yield the differences in the tmp directories as follows:

267 lnx12 ~/test > diff −r TTT0 TTT1
diff −r TTT0/tmp/file1 TTT1/tmp/file1
1c1
< ModifiedToken
---
> sdfsdf
diff −r TTT0/tmp/file2 TTT1/tmp/file2
1a2
> AddedToken
268 lnx12 ~/test >.

In the implementation of a diff of TTT0 with TTT1, the content of the /tmp directories could be as follows (note: a diff option to implement the rule was added in case one does not take care of the top directory):

270 lnx12 ~/test > diff −x tmp TTT0 TTT1
271 lnx12 ~/test >

In this case, a more elaborate rule might say;
“do not take care of the /tmp directory unless you detect that a virus was introduced in the /tmp directory.”

A non-limiting example of an implementation of the above rule could be the following:
1) Compare TTT0 and TTT1 without taking care of the /tmp directory (i.e., exactly as in the previous case).
2) Generate a list TMPSuspect List of all the additional or modified files of TTT0/tmp as compared to TTT1/tmp.
3) Apply a virus detection program (named in the following VIRUSDetector.sh, on each of the files listed in TMPSuspectList

With regard to the above example, Step 2 could be implemented, for example by;

277 lnx12 ~/test > diff −qr TTT0/tmp TTT1/tmp | awk ‘ { print
$2}’> TMPSuspectList.

In addition, the implementation of Step 3 could consist of applying the VIRUSDetector.sh software on each of the files listed with TMPSuspectList and finally output as potential problems the files for which the VIRUSDetector.sh software gave an indication that this may be a piece of malware.

FIG. 2 illustrates a flow diagram for monitoring a change in two servers. In particular, FIG. 2 includes storing a snapshot of the file system of the two servers before a change is applied at A₀, B₀. After the change is applied, a snapshot of the file systems of the two servers is also stored at A₁, B₁. Creating difference results occurs at C_{A}, C_{B}, wherein predetermined creation rules R_{A},R_{B}, are used to identify the difference results that are store at D_{A}, D_{B}, respectively,

An example will further illustrate the method implemented in FIG. 2. A Change X is a script that replaces the network mask from 255,255.255.224 to 255.255,255.0. A Change Y is a script that replaces the network mask from 255.255,255.224 to 255.255.0.0. Difference Results (DiffResults) D_{A}, D_{B} in /etc/sysconfig/network/ifcfg-eth0 would, respectively show:

```
          −NETMASK=‘255.255.255.224‘
            +NETMASK=‘255.255.255.0‘.
and
        −NETMASK=‘255.255.255.224‘
            +NETMASK=‘255.255.0.0‘.
```

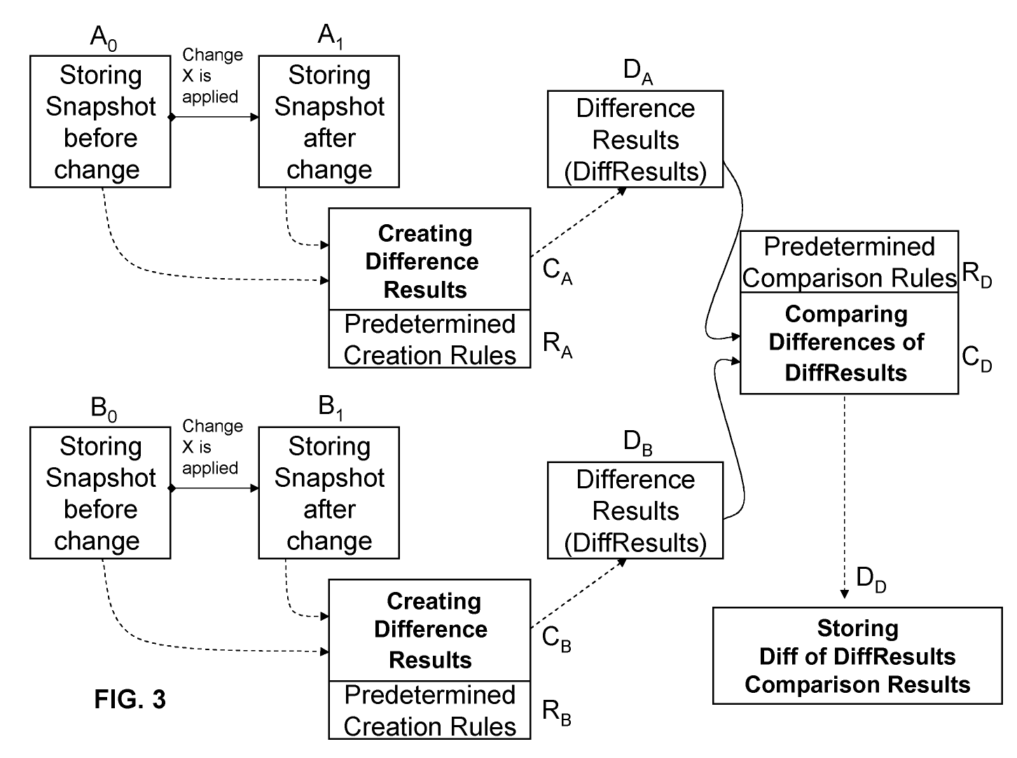

FIG. 3 illustrates a flow diagram for monitoring a change in two servers that includes comparing differences and storing results. In particular, FIG. 3 includes storing a snapshot of the file system of the two servers before a change is applied at A₀, B₀. After the change is applied, a snapshot of the file systems of the two servers is also stored at A₁, B₁. Creating difference results occurs at C_{A}, C_{B}, wherein predetermined creation rules R_{A},R_{B}, are used to identify the difference results that are store at D_{A}, D_{B}, respectively. The difference results are next compared at C_{D} wherein predetermined comparison rules R_{D} are used to compare the difference between difference results (DiffResults). These values D_{D} are then stored for further analysis.

An example will further illustrate the method implemented in FIG. 3. In particular, DiffResults are determined for both servers A and B in /etc/sysconfig/network/ifcfg-eth0 and would show:

−NETMASK=‘255.255.255.224’
+NETMASK=‘255.255.255.0

That is, a comparison between A and B will show identical DiffResults. In addition, note that other lines in /etc/sysconfig/network/ifcfg-eth0 of servers A and B may be different before and after the change. For example on A: IPADDR=‘10.1.1.1’; and on B: IPADDR=‘10.1.1.2’. Further, DiffResults might also show differences in the /var/log and /tmp directories. The predetermined comparison rules may instruct the method to ignore these differences.

Alternatively, if B is a windows machine so only the registry is changed. The comparison between A and B will show very different values for DiffResults. In addition, an example of one of the predetermined rules having an intent of detecting a different install root point of a given application that was modified) could, be as follows:
if the difference set that comes from the various servers comprises a set of files that differ by their first path element.

Further for this example:for server A you get a difference set of:

rootA/firstFile
rootA/secondFile
rootA/firstDirectory/thirdFile
rootA/secondDirectory/fourthFile
for server B you get a difference set of: rootB/firstFile
rootB/secondFile rootB/firstDirectory/thirdFile.

Then you compare the two different sets by not taking care of the the fact that rootA may be different from rootB. That is, in the previous example you would get as sole difference;
rootA/secondDirectory/forthFile.

The implementation of such a rule could be done, for example with standard UNIX/LINUX tools (e.g., shell/gawk/etc.).

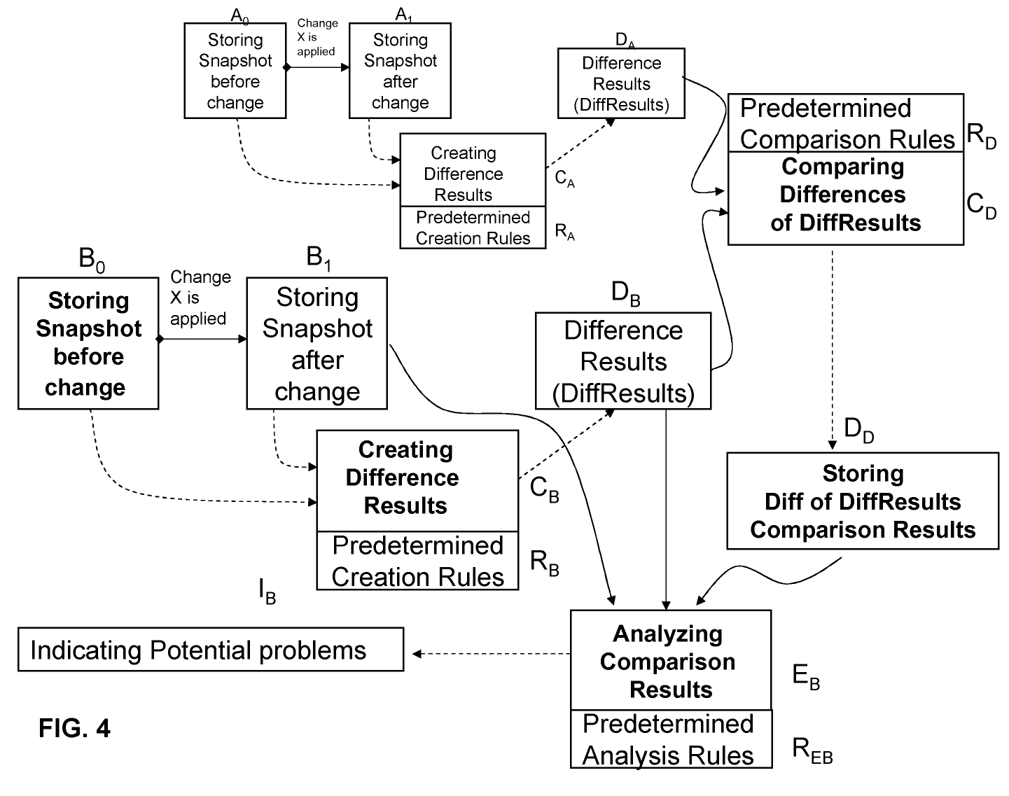

FIG. 4 illustrates a flow diagram for monitoring a change in at least two servers that includes comparing, storing and analyzing differences to identify potential problems. In particular, FIG. 4 includes storing a snapshot of the file system of the two servers before a change is applied at A₀, B₀. After the change is applied, a snapshot of the file systems of the two servers is also stored at A₁, B₁. Creating difference results occurs at C_{A}, C_{B}, wherein predetermined creation rules R_{A},R_{B}, are used to identity the difference results that are store at D_{A}, D_{B}, respectively. The difference results are next compared at C_{D} wherein predetermined comparison rules R_{D} are used to compare the difference between difference results (DiffResults). These values D_{D} are then stored for former analysis which occurs at E_{B} in accordance with predetermined analysis rules of R_{EB}. Depending on the content of the predetermined analysis rules R_{EB}, an indication of potential problem areas in the servers is indicated at I_{B}.

An example will further illustrate the method implemented in FIG. 4. In particular, if DiffResults also captures tracks changes and detects differences in the /var/log and /tmp directories a comparison between servers A and B will show that there is a potential problem. However, the predetermined analysis rules REB may instruct the method to ignore these potential problems. Assuming compare rules did not ignore the situation.

Alternatively, if there are too many differences then analysis rules may still indicate a potential problem. An example might, be that 5 log lines were added on server A during the change while 5000 log lines were added on server B during the change. This situation could indicate a problem on server B or it could be that server B is okay if B is running some other programs that log a lot of information. These particular differences between servers can be accounted for in defining the various predetermined rules discussed above.

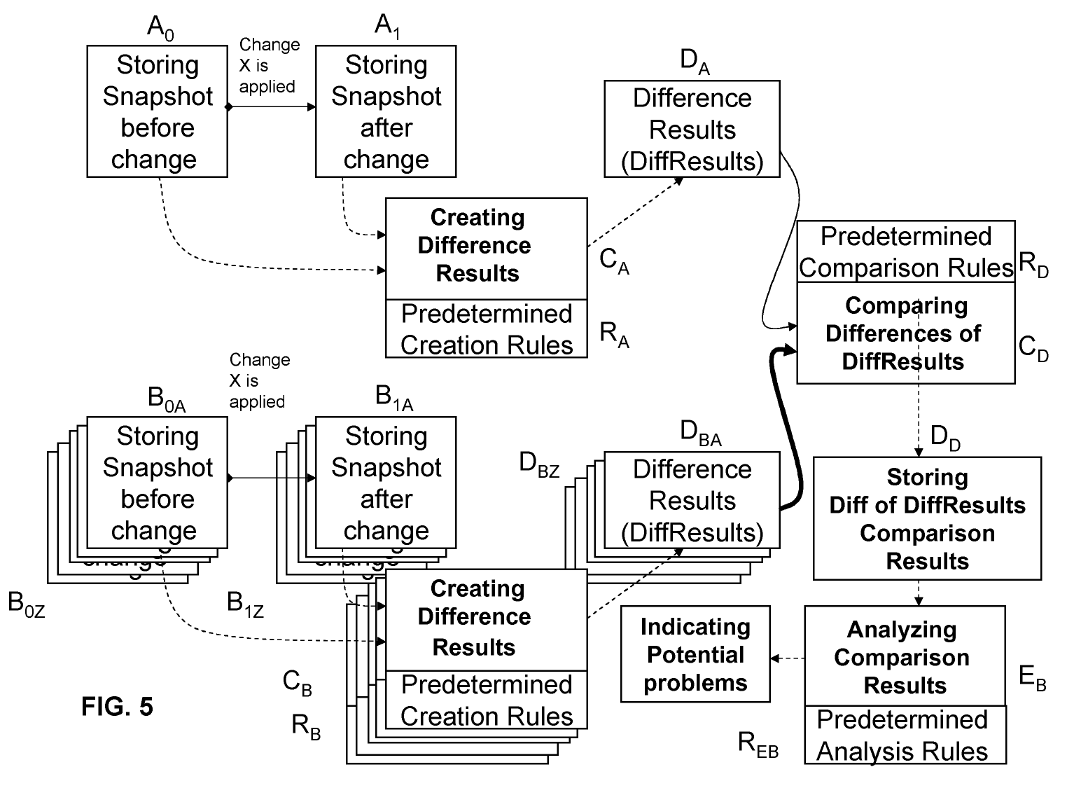

FIG. 5 illustrates a flow diagram for monitoring a change in a plurality of servers that Includes comparing, storing and analyzing differences to identify potential problems. In particular, FIG. 5 includes storing a snapshot of the file system of one server (the reference server) before a change is applied at A₀. After the change is applied, a snapshot of the file systems of the one server is also stored at A₁. Creating difference results occurs at C_{A}, wherein predetermined creation rules R_{A}, are used to identify the difference results that are stored at D_{A}.

Further, FIG. 5 includes storing snapshots of the file system of at least one server before changes are applied at B₀. After the changes are applied, snapshots of the file systems of the at least one server are also stored at B₁. Creating difference results occurs at C_{B}, wherein predetermined creation rules R_{B}, are used to identify the difference results that are stored at D_{B}.

The difference results D_{A}, D_{B} are next compared at C_{D} wherein predetermined comparison rules R_{D} are used to compare the difference between difference results (DiffResults). These values D_{D} are then stored for further analysis which occurs at E_{B} in accordance with predetermined analysis rules of R_{EB}. Depending on the content of the predetermined analysis rules R_{EB}, an indication of potential problem areas in the servers is indicated at I_{B}.

An example will further illustrate the method implemented in FIG. 5. In particular, DiffResults may be very different for the case of a windows machine A and a UNIX machine B. A multi-way compare between server A and server B, will indicate that there is a potential problem.

Alternatively, there could be only two types of DiffResults One that is the same for all windows machines A and one that is the same for all UNIX machines B. In this scenario, no problems would be indicated. A gold server is explicitly designated as such; namely, the administrator tests the results on a particular servers to validate the changes and then marks that server as “golden” to be used to verify the change on other servers. Here, however, the “good” servers are implicitly recognized˜˜a multi-way compare identifies which diffresults are “normal”/“popular” and which are “unqiue”/“rare”˜˜rather than assessing the correctness of the change by testing one golden server, the “pattern” of a golden server is identified by popularity.

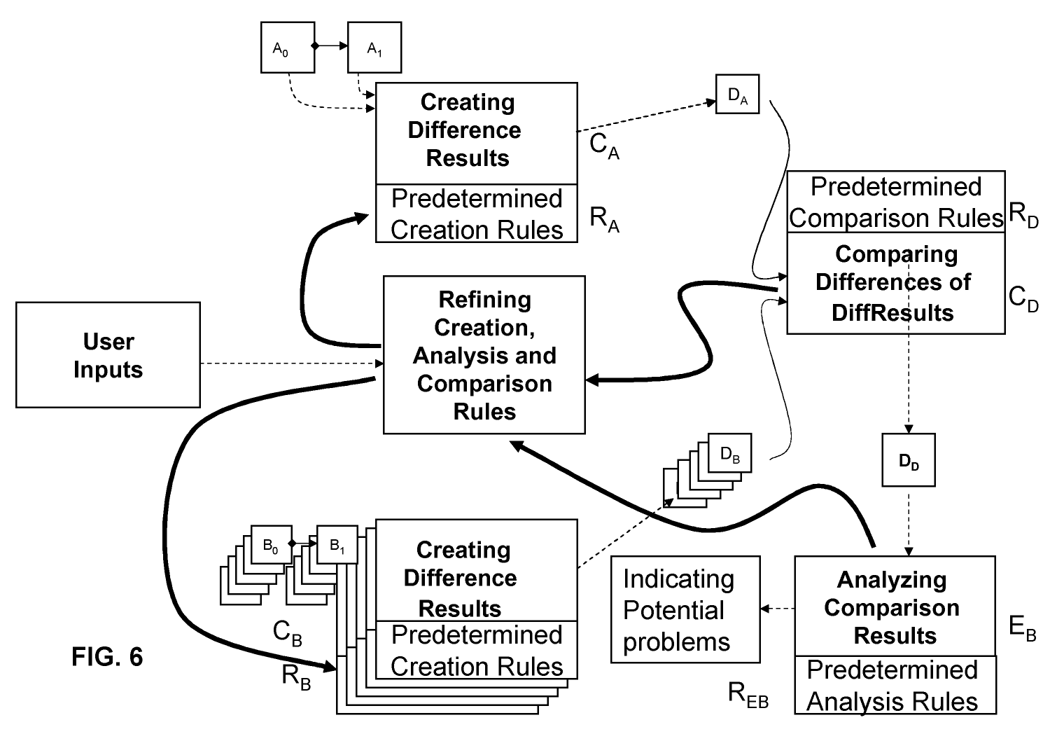

FIG. 6 illustrates yet another flow diagram for monitoring a change in a plurality of servers that includes refining the various creation rules to identify potential problems. In particular, FIG. 6 includes any of the the configurations for A₀, A₁, B₀ and B₁, as shown in FIG. 1A to FIG. 1C. Creating difference results occurs at C_{A}, wherein predetermined creation rules R_{A}, are used to identify the difference results that are stored at D_{A}. Further, creating difference results also occurs at C_{B}, wherein predetermined creation rules R_{B}, are used to identify the difference results that are stored at D_{B}.

Predetermined creation rules R_{A}, R_{B} may be modified by being further refined based on feedback from comparing differences of DiffResults at C_{D} and analyzing Comparison Results at E_{B}. This refinementThe difference results D_{A}, D_{B} are next compared at C_{D} wherein predetermined comparison rules R_{D} are used to compare the difference between difference results (DiffResults). These values D_{D} are then stored for further analysis which occurs at E_{B} in accordance with predetermined analysis rules of R_{EB}. Depending on the content of the predetermined analysis rules R_{EB}, an indication of potential problem areas in the servers is indicated at I_{B}.

The foregoing description illustrates and describes embodiments of the present invention. Additionally, the disclosure shows and describes only the preferred embodiments of the invention, but as mentioned above, it is to be understood that the invention is capable of use In various other combinations, modifications, and environments and is capable of changes or modifications within the scope of the Inventive concept as expressed herein, commensurate with the above teachings and/or skill or knowledge of the relevant art. The embodiments described hereinabove are further intended to explain best modes known of practicing the invention and to enable others skilled in the art to utilize the invention in such or other embodiments and with the various modifications required by the particular applications or uses of the invention. Accordingly, the description is not intended to Limit the invention to the form or application disclosed herein. Also, It is Intended that the appended, claims be construed to include alternative embodiments,

In addition, embodiments of the invention can take the form of an entirely hardware embodiment, an entirely software embodiment or an embodiment containing both hardware and software elements. In a preferred embodiment, the invention Is implemented in software, which includes but is not limited to firmware, resident software, microcode, etc. Furthermore, the invention can take the form of a computer program product, accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid, state memory, magnetic tape, a removable computer diskette, a random access memory (RAM), a read-only memory (ROM), a rigid magnetic disk and an optical disk. Current examples of optical disks include, but are not limited to, compact disk read only memory (CDROM), compact disk-read/write (CD-RIW) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and. Ethernet cards are just a few of the currently available types of network adapters.

1. A method for monitoring changes in a plurality of servers, comprising:
creating difference results that encapsulate effects of changes applied to file systems of at least one reference server, a first set of predetermined creation rules identify and define difference results of the file systems of the at least one reference server to be stored and analyzed;
creating difference results that encapsulate effects of changes applied to file systems of at least two additional servers, wherein a second set of predetermined creation rules identify and define difference results of the file systems of the at least two additional servers to be stored and analyzed;
comparing the stored difference results between the at least one reference server to the stored difference results of the at least two additional servers to detect differences in the respective results, wherein the detected differences are defined in accordance with predetermined comparison rules;
analyzing the detected differences in comparison results in accordance with predetermined analysis rules; and
indicating potential problems from the analyzed and detected differences,
wherein the first set of predetermined creation rules and the second set of predetermined creation rules are refined based on feedback from the comparing and analyzing.

2. The method of claim 1, further comprising reconstructing a pre-change file, for each of the file systems of at least one reference server, from a respective current file including changes applied to each of the file systems of the at least one reference server and change information stored in snapshot data.

3. The method of claim 2, wherein the reconstructed pre-change file is compared to the respective current file to create the difference results for each of the file systems of at least one reference server.

4. The method of claim 2, wherein the snapshot data includes data in the pre-change file that would have been overwritten in the respective current file.

5. The method of claim 1, wherein the creating difference results that encapsulate effects of changes applied to file systems of the at least one reference server comprises:
monitoring and tracking changes to each file system of the at least one reference server;
creating difference results using outputs of the monitoring and tracking changes; and
identifying difference results to be stored using the first set of predetermined creation rules.

6. The method of claim 1, wherein the creating difference results that encapsulate effects of changes applied to file systems of the at least two additional servers comprises:
monitoring and tracking changes to each file system of the at least two additional servers;
creating difference results using outputs of the monitoring and tracking changes; and
identifying difference results to be stored using the second set of predetermined creation rules.

7. The method of claim 1, wherein the comparing comprises using the predetermined comparison rules to instruct that differences of the stored difference results between the at least one reference server and the stored difference results of the at least two additional servers be ignored.

8. The method of claim 1, wherein the analyzing comprises using predetermined analysis rules to instruct that potential problems be ignored.

9. The method of claim 1, wherein the first set of predetermined creation rules indicate that changes applied to the file systems of the at least one reference server is to be recorded so that a pre-change file can be reconstructed, and
wherein the second set of predetermined creation rules indicate that changes applied to the file systems of the at least two additional servers are to be recorded so that pre-change files can be reconstructed for the file systems of the at least two additional servers.

10. The method of claim 1, further comprising:
reconstructing a pre-change file for each of the file systems of the at least two additional servers from current files including changes applied to file systems of the at least two additional servers and change information stored in snapshot data,
wherein the reconstructed pre-change file for each of the file systems of the at least two additional servers is compared to a respective current file to create the difference results of each of the file systems of the at least two additional servers, and
wherein the snapshot data includes data in the pre-change file that would have been overwritten in the respective current file.

11. An apparatus for monitoring changes in a plurality of servers, comprising:
means for creating difference results that encapsulate effects of changes applied to file systems of at least one reference server, wherein a first set of predetermined creation rules identify and define difference results of the file systems of the at least one reference server to be stored and analyzed;
means for creating difference results that encapsulate effects of changes applied to file systems of at least two additional servers, wherein a second set of predetermined creation rules identify and define difference results of the file systems of the at least two additional servers to be stored and analyzed;
means for comparing the stored difference results between the at least one reference server to the stored difference results of the at least two additional servers to detect differences in the respective results, wherein the detected differences are defined in accordance with predetermined comparison rules;
means for analyzing the detected differences in comparison results in accordance with predetermined analysis rules; and
means for indicating potential problems from the analyzed and detected differences,
wherein the first set of predetermined creation rules and the second set of predetermined creation rules are refined based on feedback from the comparing and analyzing.

12. The apparatus of claim 11, further comprising means for reconstructing a pre-change file for file systems of the at least one reference server from a current file including changes applied to file systems of the at least one reference server and change information stored in snapshot data.

13. The apparatus of claim 12, wherein the reconstructed pre-change file is compared to the current file to create the difference results of the file systems of the at least one reference server.

14. The apparatus of claim 12, wherein the snapshot data includes data in the pre-change file that would have been overwritten in the current file.

15. The apparatus of claim 11, wherein the means for creating difference results that encapsulate effects of changes applied to file systems of the at least one reference server comprises:
means for monitoring and tracking changes to each file system of the at least one reference server;
means for using outputs of the monitoring and tracking changes to create difference results; and
means for identifying difference results to be stored using the first set of predetermined creation rules.

16. The apparatus of claim 11, wherein the means for creating difference results that encapsulate effects of changes applied to file systems of the at least two additional servers comprises:
means for monitoring and tracking changes to each file system of the at least two additional servers;
means for using outputs of the monitoring and tracking changes to create difference results; and
means for identifying difference results to be stored using the second set of predetermined creation rules.

17. The apparatus of claim 11, wherein the means for comparing comprises means for using the predetermined comparison rules to instruct that differences of the stored difference results between the at least one reference server and the stored difference results of the at least two additional servers be ignored.

18. The apparatus of claim 11, wherein the means for analyzing comprises means for using predetermined analysis rules to instruct that potential problems be ignored.

19. The apparatus of claim 11, wherein the first set of predetermined creation rules indicate that changes applied to the file systems of the at least one reference server is to be recorded so that a pre-change file can be reconstructed, and
wherein the second set of predetermined creation rules indicate that changes applied to the file systems of the at least two additional servers are to be recorded so that pre-change files can be reconstructed for the file systems of the at least two additional servers.

20. The apparatus of claim 11, further comprising:
means for reconstructing a pre-change file for each of the file systems of the at least two additional servers from current files including changes applied to file systems of the at least two additional servers and change information stored in snapshot data,
wherein the reconstructed pre-change file for each of the file systems of the at least two additional servers is compared to a respective current file to create the difference results of each of the file systems of the at least two additional servers, and
wherein the snapshot data includes data in the pre-change file that would have been overwritten in the respective current file for each of the file systems of the at least two additional servers.
